(19) United States
(12) Patent Application Publication
(10) Pub. No.: US 2005/0086664 A1
(43) Pub. Date: Apr. 21, 2005

(54) Method and apparatus for transaction tracking in a web presentation architecture

(76) Inventors: Sankar Ram Sundaresan, San Jose, CA (US); Jeff A. Parks, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/676,219

(22) Filed: Oct. 1, 2003

(51) Int. Cl. G06F 3/00; G06F 13/00; G06F 15/16

(52) U.S. Cl. 719/312; 707/10; 709/203

(57) ABSTRACT

The disclosed embodiments relate to a system and method for creating applications, such as web applications. The system may comprise a controller generator that is adapted to provide an application with a controller that receives a request to perform a transaction and completes the transaction by responding to the request. The system may also include transaction tracking logic that is adapted to provide the application with a plurality of transaction managers, each transaction manager being adapted to record tracking information about transactions of a specific type.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

A user may initiate a web transaction with a web application by sending information to the web application via a browser or the like. A web transaction is everything that happens from when the web application receives the request until it returns a response to the user. The web application may access data resources or otherwise obtain information from a variety of sources in response to a user request.

Designers and managers of web sites may find it useful to analyze performance data about the processing of transactions for web applications. Performance data may be collected and stored in logs for later analysis. If the architecture for web applications does not provide the ability to track and log transaction data, developers may not have access to certain types of information, such as information that may be stored in error logs. Some basic types of performance information may be determined using generic transaction analysis tools, such as timing software or the like. However, those tools may not give the specific detail that web application developers might need to analyze desired performance attributes.

### BRIEF DESCRIPTION OF THE DRAWINGS

Advantages of one or more disclosed embodiments may become apparent upon reading the following detailed description and upon reference to the drawings in which:

FIG. 1 is a block diagram that illustrates a model-view-controller (“MVC”) application architecture, which may be created using embodiments of the present invention may be employed;

FIG. 2 is a block diagram that illustrates a web presentation architecture in accordance with embodiments of the present invention;

FIG. 3 is a block diagram that illustrates the operation of a web application program created using a web presentation architecture in accordance with embodiments of the present invention;

FIG. 4 is an object diagram of an architecture for transaction classes in accordance with embodiments of the present invention;

FIG. 5 is an object diagram of an architecture for a performance activity manager in accordance with embodiments of the present invention;

FIG. 6 is an object model diagram illustrating the relationship of the TransactionImpl object with activity managers and persist commands in accordance with embodiments of the present invention;

FIG. 7 is an object model diagram illustrating logging classes in accordance with embodiments of the present invention; and

FIG. 8 is an object model diagram illustrating the relationship between the logging configuration class and the log classes in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

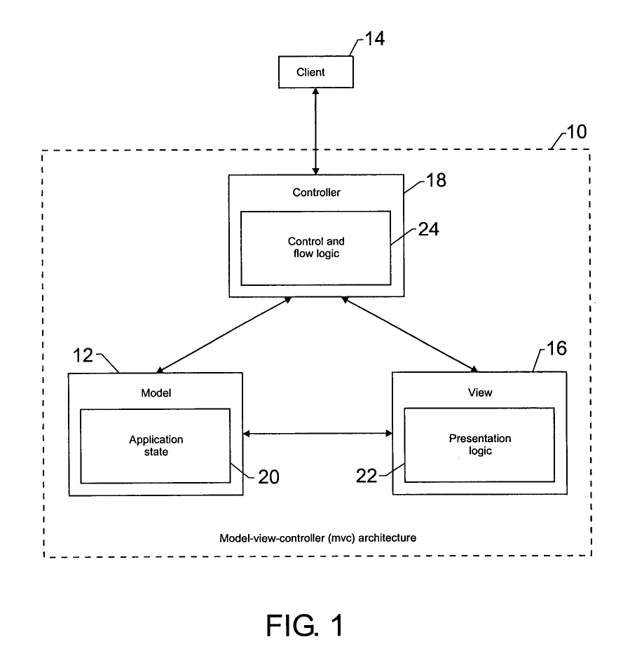

FIG. 1 is a block diagram that illustrates a model-view-controller (“MVC”) application architecture, which may be created using embodiments of the present invention. As illustrated, the MVC architecture 10 separates the application object or model 12 from a view 16, which is responsible for receiving an input and presenting an output to a client 14. In a web application context, the client 14 may comprise a browser. The model object and the view are also separated from the control functions of the application, which are represented in FIG. 1 as a controller 18. In general, the model 12 comprises an application state 20, the view 16 comprises presentation logic 22, and the controller 18 comprises control and flow logic 24. By separating these three MVC objects 12, 16, and 18 with abstract boundaries, the MVC architecture 10 may provide flexibility, organization, performance, efficiency, and reuse of data, presentation styles, and logic.

The WPA 100 may be configured with a variety of object-oriented programming languages, such as Java by Sun Microsystems, Inc., Santa Clara, Calif. An object is generally any item that can be individually selected and manipulated. In object-oriented programming, an object may comprise a self-contained entity having data and procedures to manipulate the data. For example, a Java-based system may utilize a variety of JavaBeans, servlets, Java Server Pages, and so forth. JavaBeans are independent, reusable software modules. In general, JavaBeans support introspection (a builder tool can analyze how a JavaBean works), customization (developers can customize the appearance and behavior of a JavaBean), events (JavaBeans can communicate), properties (developers can customize and program with JavaBeans), and persistence (customized JavaBeans can be stored and reused). JSPs provide dynamic scripting capabilities that work in tandem with HTML code, separating the page logic from the static elements. According to certain embodiments, the WPA 100 may be designed according to the Java 2 Platform Enterprise Edition (J2EE), which is a platform-independent, Java-centric environment for developing, building and deploying multi-tiered Web-based enterprise applications online.

The model 12 comprises a definitional framework representing the application state 20. For example, in a web-based application, the model 12 may comprise a JavaBean object or other suitable means for representing the application state 20. Regardless of the application or type of object, an exemplary model 12 may comprise specific data and expertise or ability (methods) to get and set the data (by the caller). The model 12 generally focuses on the intrinsic nature of the data and expertise, rather than the extrinsic views and extrinsic actions or business logic to manipulate the data. However, depending on the particular application, the model 12 may or may not contain the business logic along with the application state. For example, a large application having an application tier may place the business logic in the application tier rather than the model objects 12 of the web application, while a small application may simply place the business logic in the model objects 12 of the web application.

As noted above, the view and controller objects 16 and 18 separately address these extrinsic views and actions or business logic. For example, the model 12 may represent data relating to a person (e.g., an address, a birth date, phone number, etc.), yet the model 12 is independent of extrinsic formats (e.g., a date format) for displaying the personal data or extrinsic actions for manipulating the personal data (e.g., changing the address or phone number). Similarly, the model 12 may represent data and expertise to track time (e.g., a clock), yet the model 12 is independent of specific formats for viewing the clock (e.g., analog or digital clock) or specific actions for manipulating the clock (e.g., setting a different time zone). These extrinsic formats and extrinsic actions are simply not relevant to the intrinsic behavior of the model clock object. One slight exception relates to graphical model objects, which inherently represent visually perceptible data. If the model 12 represents a particular graphical object, then the model 12 has expertise to draw itself while remaining independent of extrinsic formats for displaying the graphical object or extrinsic actions for creating or manipulating the graphical object.

The view 16 generally manages the visually perceptible properties and display of data, which may be static or dynamic data derived in whole or in part from one or more model objects 12. As noted above, the presentation logic 22 functions to obtain data from the model 12, format the data for the particular application, and display the formatted data to the client 14. For example, in a web-based application, the view 16 may comprise a Java Server Page (JSP page) or an HTML page having presentation logic 22 to obtain, organize, format, and display static and/or dynamic data. Standard or custom action tags (e.g., jsp:useJavaBean) may function to retrieve data dynamically from one or more model objects 12 and insert model data within the JSP pages. In this manner, the MVC architecture 10 may facilitate multiple different views 16 of the same data and/or different combinations of data stored by one or more model objects 12.

The controller 18 functions as an intermediary between the client 14 and the model object 12 and view 16 of the application. For example, the controller 18 can manage access by the view 16 to the model 12 and, also, manage notifications and changes of data among objects of the view 16 and objects of the model 12. The control and flow logic 24 of the controller 18 also may be subdivided into model-controllers and view-controllers to address and respond to various control issues of the model 12 and the view 16, respectively. Accordingly, the model-controllers manage the models 12 and communicate with view-controllers, while the view-controllers manage the views 16 and communicate with the model-controllers. Subdivided or not, the controllers 18 ensure communication and consistency between the model 12 and view 16 and the client 14.

In operation, the control and flow logic 24 of the controller 18 generally receives requests from the client 14, interprets the client requests, identifies the appropriate logic function or action for the client requests, and delegates responsibility of the logic function or action. Requests may be received from the client via a number of protocols, such as Hyper Text Transfer Protocol (“HTTP”) or HTTP with Secure Sockets Layer (“HTTPS”). Depending on the particular scenario, the appropriate logic function or action of the controller 18 may include direct or indirect interaction with the view 16 and/or one or more model objects 12. For example, if the appropriate action involves alteration of extrinsic properties of data (e.g. reformatting data in the view 16), then the controller 18 may directly interact with the view 16 without the model 12. Alternatively, if the appropriate action involves alteration of intrinsic properties of data (e.g., values of data in the model 12), then the controller 18 may act to update the corresponding data in the model 12 and display the data in the view 16.

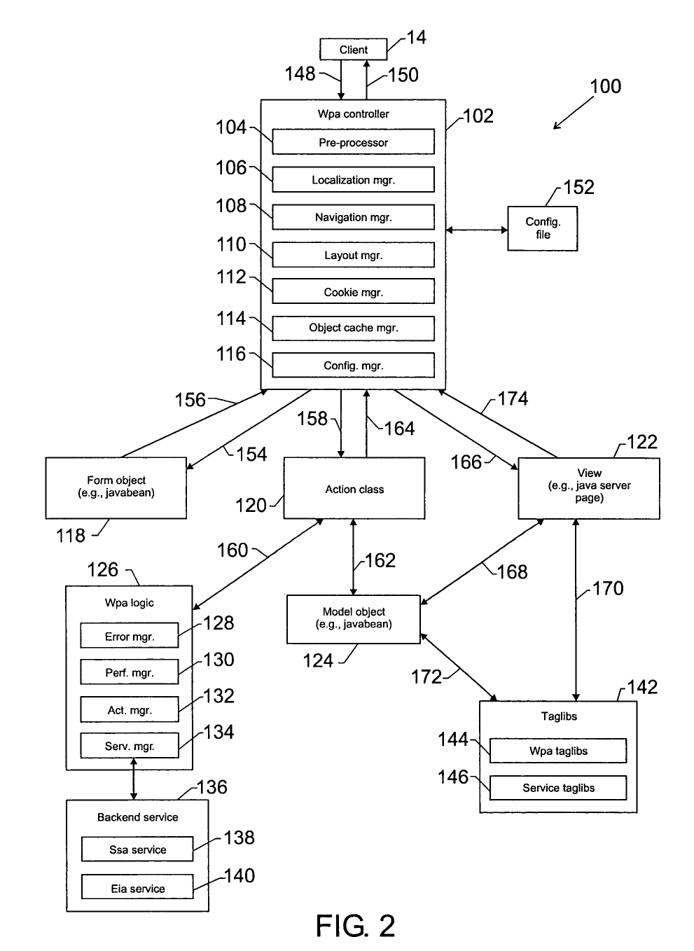

FIG. 2 is a block diagram illustrating an exemplary web presentation architecture (“WPA”) 100 in accordance with certain embodiments of the present invention. The illustrated WPA 100, which may be adapted to execute on a processor-based device such as a computer system or the like, has certain core features of the MVC computing strategy, and various additional features and enhancements to improve its architectural operation and performance. For example, the illustrated WPA 100 separates the model, the view, and the controller as with the traditional MVC architecture, yet the WPA 100 provides additional functionality to promote modularity, flexibility, and efficiency.

As illustrated, the WPA 100 comprises a WPA controller 102 having a preprocessor 104, a localization manager 106, the navigation manager 108, a layout manager 110, a cookie manager 112, and object cache manager 114, and a configuration manager 116. The WPA controller 102 functions as an intermediary between the client 14, form objects 118, action classes 120, and views 122. In turn, the action classes 120 act as intermediaries for creating/manipulating model objects 124 and executing WPA logic 126, such as an error manager 128, a performance manager 130, and activity manager 132, and a backend service manager 134. As described below, the backend service manager 134 functions to interface backend services 136. Once created, the model objects 124 can supply data to the view 122, which can also call various tag libraries 142 such as WPA tag libraries 144 and service tag libraries 146.

In operation, the client 14 sends a request 148 to the WPA 100 for processing and transmission of a suitable response 150 back to the client 14. For example, the request 148 may comprise a data query, data entry, data modification, page navigation, or any other desired transaction. As illustrated, the WPA 100 intakes the request 148 at the WPA controller 102, which is responsible for various control and flow logic among the various model-view-controller divisions of the WPA 100. For example, the WPA controller 102 can be implemented as a Servlet, such as a HyperText Transfer Protocol (“HTTP”) Servlet, which extends the ActionServlet class of Struts (an application framework promulgated by the Jakarta Project of the Apache Software Foundation). As illustrated, the WPA controller 102 invokes a configuration resource file 152, which provides mapping information for form classes, action classes, and other objects. Based on the particular request 148, the WPA controller 102 locates the appropriate action class and, also, the appropriate form class if the request 148 contains form data (e.g., client data input). For example, the WPA controller 102 may lookup a desired WPA Action Form and/or WPA Action Class, which function as interfaces to WPA Form Objects and WPA Action Objects.

If the client entered data, then the WPA controller 102 creates and populates the appropriate form object 118 as indicated by arrow 154. The form object 118 may comprise any suitable data objects type, such as a JavaBean, which functions to store the client entered data transmitted via the request 148. The WPA controller 102 then regains control as indicated by arrow 156.

If the client did not enter data, or upon creation and population of the appropriate form object 118, then the WPA controller 102 invokes the action class 120 to execute various logic suitable to the request 148 as indicated by arrow 158. For example, the action class 120 may call and execute various business logic or WPA logic 126, as indicated by arrow 160 and discussed in further detail below. The action class 120 then creates or interacts with the model object 124 as indicated by arrow 162. The model object 124 may comprise any suitable data object type, such as a JavaBean, which functions to maintain the application state of certain data. One example of the model object 124 is a shopping cart JavaBean, which stores various user data and e-commerce items selected by the client. However, a wide variety of model objects 124 are within the scope of the WPA 100. After executing the desired logic, the action class 120 forwards control back to the WPA controller 102 as indicated by arrow 164, which may be referred to as an “action forward.” This action forward 164 generally involves transmitting the path or location of the server-side page, e.g., the JSP.

As indicated by arrow 166, the WPA controller 12 then invokes the foregoing server-side page as the view 122. Accordingly, the view 122 interprets its links or tags to retrieve data from the model object 124 as indicated by arrow 168. Although a single model object 124 is illustrated, the view 122 may retrieve data from a wide variety of model objects. In addition, the view 122 interprets any special logic links or tags to invoke tag libraries 142 as indicated by arrow 170. For example, the WPA tag libraries 144 and the service tag libraries 146 can include various custom or standard logic tag libraries, such as <html>, <logic>, <template> developed as part of the Apache Jakarta Project or the like. Accordingly, the tag libraries 142 further separate the logic from the content of the view 122, thereby facilitating flexibility and modularity. In certain cases, the tag libraries 142 also may interact with the model object 124 as indicated by arrow 172. For example, a special tag may execute logic to retrieve data from the model object 124 and manipulate the retrieved data for use by the view 122. After interacting with the model object 124 and the appropriate tag libraries 142, the WPA 100 executes the view 122 (e.g., JSP) to create a client-side page for the client 14 as indicated by arrow 174. For example, the client-side page may comprise an Extensible Markup Language (“XML”) or HTML formatted page, which the WPA controller 102 returns to the client 14 via the response 150.

As discussed above, the WPA 100 comprises a variety of unique logic and functional components, such as control components 104 through 116 and logic 128 through 134, to enhance the performance of the overall architecture and specific features 100. These components and logic generally operate on the server-side of the WPA 100, yet there are certain performance improvements that may be apparent on the client-side. These various components, while illustrated as subcomponents of the controller 102 or types of logic 126, may be standalone or integrated with various other portions of the WPA 100. Accordingly, the illustrated organization of these components is simply one exemplary embodiment of the WPA 100, while other organizational embodiments are within the scope of the present technique.

Turning to the subcomponents of the WPA controller 102, the preprocessor 104 provides preprocessing of requests by configuring portal specific functions to execute for each incoming request registered to the specific portal. The preprocessor 104 identifies the appropriate portal specific functions according to a preset mapping, e.g., a portal-to-function mapping in the configuration file 152. Upon completion, the preprocessor 104 can redirect to a remote Uniform Resource Identifier (URI), forward to a local URI, or return and continue with the normal processing of the request 148 by the WPA controller 102. One example of such a preprocessing function is a locale, which is generally comprised of language preferences, location, and so forth. The preprocessor 104 can preprocess local logic corresponding to a particular portal, thereby presetting language preferences for subsequent pages in a particular application.

The locale information is also used by the localization manager 106, which functions to render localized versions of entire static pages rather than breaking up the static page into many message strings or keys. Instead of using a single page for all languages and obtaining localized strings from other sources at run time, the localization manager 106 looks up a localized page according to a locale identifier according to a preset mapping, e.g., a locale-to-localized page mapping in the configuration file 152.

The navigation manager 108 generally functions to save a users intended destination and subsequently recall that information to redirect the user back to the intended destination. For example, if the user intends to navigate from point A to point B and point B queries for certain logic at point C (e.g., a user login and password), then the navigation manager 108 saves the address of point B, proceeds to the requested logic at point C, and subsequently redirects the user back to point B.

The layout manager 110 enables a portal to separate the context logic functioning to render the common context from the content logic functioning to render the content portion of the page. The common context (e.g., C-Frame) may include a header, a bottom portion or footer, and a side portion or side bar, which collectively provides the common look and feel and navigational context of the page.

The cookie manager 112 functions to handle multiple cookie requests and to set the cookie value based on the most recent cookie request before committing a response. For example, in scenarios where multiple action classes attempt to set a particular cookie value, the cookie manager 112 caches the various cookie requests and defers setting the cookie value until response time. In this manner, the cookie manager 112 ensures that different action classes do not erase cookie values set by one another and, also, that only one cookie can exist with a particular name, domain, and path.

The object cache manager 114 enables applications to create customized in-memory cache for storing objects having data originating from backend data stores, such as databases or service based frameworks (e.g., Web Services Description Language “WSDL”). The in-memory cache may be customized according to a variety of criteria, such as cache size, cache scope, cache replacement policy, and time to expire cache objects. In operation, the object cache manager 114 improves performance by reducing processing time associated with the data from the backend data stores. Instead of retrieving the data from the backend data stores for each individual request 148, the object cache manager 114 caches the retrieved data for subsequent use in processing later requests.

The configuration manager 116 functions to oversee the loading of frequently used information, such as an error code table, into memory at startup time of a particular web application. The configuration manager 116 may retain this information in memory for the duration of an application server session, thereby improving performance by eliminating the need to load the information each time the server receives a request.

Turning to the WPA logic 126, the error handler or manager 128 functions to track or chain errors occurring in series, catalog error messages based on error codes, and display error messages using an error catalog. The error catalog of the error manager 128 may enable the use of generic error pages, which the error manager 128 populates with the appropriate error message at run time according to the error catalog.

The WPA logic function 126 may comprise performance and activity managers 130 and 132, which may facilitate tracking and logging of information associated with a particular transaction or request. The error manager 128 may also be adapted to participate in tracking and logging operations as well.

The service manager 134 of the WPA logic 126 functions as an interface between the WPA 100 and various backend services 136. In operation, the service manager 134 communicates with the desired backend service 136 according to the client request 148, parses a response from the backend service 136 to obtain the appropriate data, and pass it to the appropriate object of WPA 100.

As set forth above, web presentation architecture constructed according to embodiments of the present invention may support transaction tracking and logging. Transaction classes may allow web applications to gather data during a transaction and log that data to predefined log files. Specifically, the data gathered may be broken into the three categories of business activity information, error information and performance information. A debug log may also be employed to log information that does not fall in the previous three categories.

A concrete implementation (i.e. an implementation that may have instances or be instantiated rather than inherited) of the Transaction interface may be used to oversee an entire transaction. The main data storage objects may be referred to as a TransactionInfo object and activity manager objects. Activity manager objects may follow the command pattern and may be specialized to collect data for the three types of logs mentioned above. The performanceActivityManager method may calculate timing data. Specifically, it may calculate the time spent in the overall transaction and time spent in “layers” (these are significant pieces of the request processing, such as the LayoutManager). Services may time their own layers, which may provide an advantage for determining where performance bottlenecks and the like occur. Activity managers implement an interface, which may be referred to as the ActivityManager interface. The design is flexible and new activity managers may be added if new types of data need to be gathered.

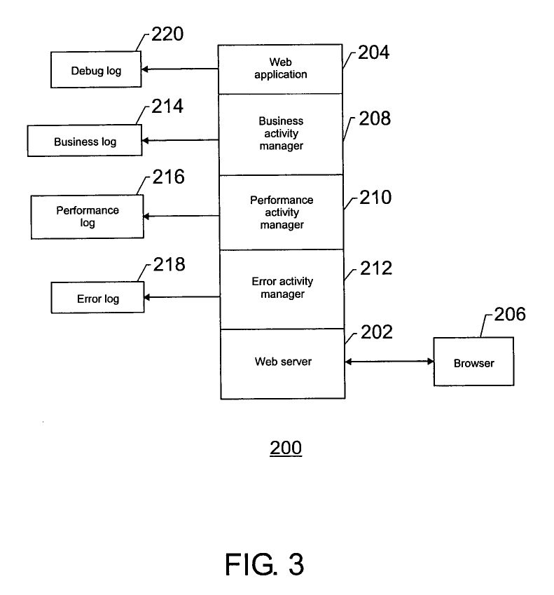

Logging may comprise accessing the data from a TransactionInfo object and the activity managers and formatting them using PersistCommand objects. PersistCommand classes are also specialized according to the log type. PersistCommands implement an interface, which may be referred to as the PersistCommand interface. Like the activity managers, new PersistCommands may be added if new formatting is needed, or if log records need to be persisted using an alternate mechanism such as writing to a file system, a database, publishing a messaging queue, a Simple Network Management Protocol (“SNMP”)-based monitoring program or the like. Those of ordinary skill in the art will appreciate that existing logging software may be employed to do the actual logging of data once that data has been obtained. The overall operation of the tracking and logging functionality of web applications created with embodiments of the present invention is illustrated with reference to FIG. 3.

FIG. 3 is a block diagram that illustrates the operation of a web application program created using a web presentation architecture in accordance with embodiments of the present invention. The diagram is generally referred to by the reference numeral 200. A web server 202 hosts a web application 204, which is constructed according to a web processing architecture according to embodiments of the present invention. A user may access the web application 204 by using a browser 206 or the like. The web application 204 embodies tracking capability, as represented by a business activity manager 208, a performance activity manager 210 and an error activity manager 212. Those of ordinary skill in the art will appreciate that the business activity manager 208, the performance activity manager 210 and the error activity manager 212 may comprise separate operating modules or may be incorporated into the web application 204.

The business activity manager 208 is adapted to gather information related to business transaction processing. The business information gathered by the business activity manager 208 may be stored in a business log 214 by the business activity manager 208 or an external logging program (not shown). The performance activity manager 210 is adapted to gather information related to the performance of the web application 204. The performance information gathered by the performance activity manager 210 may be stored in a performance log 216 by the performance activity manager 210 or an external logging program (not shown). The error activity manager 212 is adapted to gather information related to errors encountered during operation of the web application 204. The error information gathered by the error activity manager 212 may be stored in an error log 218 by the error activity manager 212 or an external logging program (not shown). A debug log 220 may be adapted to log information that is captured but not readily classified as business information, performance information or error information.

The following discussion gives many details with respect to the implementation of a web presentation architecture in accordance with embodiments of the present invention. The first portion of that discussion relates to transaction design.

Transaction Design

Architectures in accordance with embodiments of the present invention may employ a Transaction interface. The Transaction interface follows the Command pattern and is used to gather and log information about each request received by a web application constructed in accordance with embodiments of the present invention.

In general, a Transaction may comprise the two major actions of gathering/storing transaction information and logging. The present discussion is related to the design of the Transaction interface. Logging is described in detail below. Data storage objects may include the TransactionInfo object and the ActivityManager objects. ActivityManager objects, when applicable, may also oversee data gathering. Both types of objects are accessed by the TransactionImpl class, which may implement the Transaction interface. A wrapper class, TransactionProxy, may be used to limit the classes accessible by services.

Within WPA, a TransactionImpl object may be created by the Controller 102 and passed to a TransactionProxy constructor. The TransactionProxy object is then placed into request scope. During the transaction, the transaction object may then be used to gather and log performance metrics, add data to the performance and business activity logs and record the outcome of the request in terms of success or error.

The following actor objects may be implemented in web presentation architectures according to embodiments of the present invention.
Controller—may create one transaction object per request and store it in request scope so that services can access it and store data to be logged.
Transaction interface—the interface on which all clients (i.e. objects that publish information) rely on.
TransactionImpl—the implementation of the transaction interface that directly accesses activity managers and the TransactionInfo object.
TransactionPrxoy—this object may wrap the TransactionImpl class and be stored in request scope. The TransactionProxy class may have fewer methods than TransactionImpl and may limit the methods of TransactionImpl that services may access.
TransactionInfo—the object that stores various IDs and other information pertaining to an entire transaction, such as transaction ID, session ID, and visitor ID.
ActivityManager—the abstract superclass for all activity manager objects.
ErrorActivityManager—the object that stores information about each exception that will be logged for the transaction.
PerformanceActivityManager—the object that stores information about the performance metrics that will be logged for the transaction. Also oversees taking the proper measurements.
BusinessActivityManager—the object that stores information about the transaction's business activity that will be logged.
   The framework of operation of these objects is explained below with reference to FIG. 3.

The operation of the tracking and logging functionality provided by embodiments of the present invention may be better understood upon consideration of example use cases relating to various tracking and logging events. Several example use cases, including the typical flow of events for each example, are set forth below.

The following use case describes a typical course of events for a transaction and logging sequence in which performance metrics are calculated and so they may be accessed later for logging.
1. Controller receives a request to process.
2. Controller creates a TransactionImpl object.
3. Controller sets various transaction information on the transaction object, such as sessionID and the like.
4. Controller calls the TransactionImpl's startTransactionTime( ) method, which marks the current time as the start time for the transaction.
5. After the controller processes the request, it calls the transaction object's endTransactionTime( ) method, which marks the current time as the end time for the transaction.

The following use case describes a typical course of events for calculating and storing performance metrics of a layer within the transaction so that those metrics may be accessed later for logging.
1. Controller receives a request to process.
2. Controller creates a TransactionImpl object.
3. Controller sets various transaction information on the transaction object, such as sessionID and the like.
4. Controller calls the TransactionImpl's startTransactionTime( ) method to start the timing for the entire transaction.
5. For each layer, such as the action instance, the layout manager, or the localization manager, the controller may call the transaction object's startLayerTime(<layer name>), where layer name is a constant in the MetricPoint class. MetricPoint may be stored at a known location such as \pl\transaction\util. This saves the current time as the start time for the layer.
6. After each layer returns control to the controller, the controller calls endLayerTime(<layer name>), where <layer name> is the same name as was passed to startLayerTime. This saves the current time as the end time for the layer.
7. After the controller processes the request, it calls the transaction object's endTransactionTime( ) to end the timing processing for the transaction.

The following use case describes a typical course of events for calculating and storing performance metrics of code within a layer so that those metrics can be accessed later for logging.
1. Controller receives a request to process.
2. Controller creates a TransactionImpl object.
3. Controller sets various transaction information on the transaction object, such as sessionID and the like.
4. Controller calls the appropriate timing methods to start timing the transaction and the layer(s).
5. Within a layer's code, the transaction object is extracted from request scope, and its startTime(Object p_reportingObject, String p_reportingMetric) and endTime(Object p_reportingObject, String p_reportingMetric) method calls are placed around the code to be timed. The reporting object is the current object (“this”), while the reportingMetric indicates what is being timed, for example, the name of a method. The calls store the start time and the end time, respectively, for the block of code they surround.
6. WPAController calls the appropriate endTime methods to end the layer and transaction times.

The following use case describes a typical course of events for allowing a service to save extra data to be logged in the performance log file in key, value pairs.
1. Controller receives a request to process.
2. Controller creates a TransactionImpl object, does the proper initialization for it, and uses it to create a TransactionProxy object. It then saves the TransactionProxy in request scope.
3. Inside a service's action class, if it wishes to add data to the performance log file, it must extract the TransactionProxy object from the request.
4. After the service has the TransactionProxy object, it calls its logServicePerformanceInfo method, giving it a (key, value) pair. This method stores the data in the PerformanceActivityManager.

The following use case describes a typical course of events for storing exception information for output into the error log file. In this example, only system exceptions are logged.
1. The service creates a concrete instance of Exception and throws it to its action class.
2. The action class catches the exception and creates a concrete instance of ErrorActionForward by creating a SystemErrorActionForward. The ErrorActionForward has access to the TransactionProxy object and provides a logError(Exception) method.
3. The SystemErrorActionForward constructor calls the logError(Exception) method inherited from ErrorActionForward.
4. This in turn calls the logError(Exception.getErrorInfo( )) method of the TransactionProxy and stores into the ErrorActivityManager the errorInfo object associated with the Exception.

The following use case describes a typical course of events for storing exception information for output into the error log file. In this example, only system exceptions are logged. There are two types of Framework exceptions that can be processed: 1) A fatal framework exception that requires an error page be displayed to the user, and 2) A non fatal framework exception that should be logged, but for which the user does not need to see an error page.

The following illustrates a typical flow for the case of a fatal error.
1. The framework class creates a FrameworkException.
2. Because the exception is fatal, the framework class then creates a new SystemErrorActionForward, passing in the proper parameters, among them the FrameworkException.
3. The Controller goes to the error page.

The following example illustrates a typical flow for the case of a non-fatal error.
1. The framework class creates a FrameworkException and throws it to the Controller.
2. The Controller catches the exception and calls the TransactionImpl's logFrameworkException method.
3. This method may accomplish logging by.
   a. Calling the transactionImpl's logError( ) method, passing in <Exception>.getErrorInfo( ). This method results in the ErrorActivityManager storing the errorInfo object associated with the Exception.
   b. Call the transactionImpl's logSuccessIndicator method( ), passing in the integer SuccessIndicators.SYSERROR. SuccessIndicators may be found in a known location, such as an \exception directory. This results in the BusinessActivityManager storing the system exception indicator as the status.
   c. Call the transactionImpl's logErrorCode( ) method, passing in <WPAException>.getErrorCode( ). This results in the BusinessActivityManager storing the error code for logging.

The following use case describes a typical course of events for storing additional information (e.g. error messages) for later logging in an error log file.
1. When a web application or a service creates a concrete instance of Exception, it must use the constructor <ConcreteSubclassOfWPAException>(String errorMessage).
2. The web application or service may then follow the steps for storing minimum exception information.

The following use case describes a typical course of events for storing exception information for logging in a diagnostic context. Contextual information may be stored about the exception for output into the error log file.
1. A web application or a service may create a Diagnostic context object.
2. The class may then create a concrete instance of Exception and use one of two constructors, depending on the circumstances.
   a. <SubclassException>(DiagnosticContext diagnosticContext).
   b. <SubclassException>(DiagnosticContext diagnosticContext, Exception caughtException). This constructor is used when the new Exception is thrown as a result of another exception. In order to keep track of the exception sequence, it is passed into the constructor of the new exception.
3. The web application or service then follows the steps outlined in the use case about storing minimum exception information.

The following use case describes a typical course of events for storing business activity data for output into the business activity log file.
1. An Action class catches a business or system exception.
2. It then creates a concrete instance of ErrorActionForward by creating a BusinessErrorActionForward or a SystemErrorActionForward. The ErrorActionForward has access to the transaction object. By creating an instance of one of its subclasses, the proper information is stored in the BusinessActivityManager due to calls in the constructors of the action forward. For instances of both BusinessErrorActionForward and SystemErrorActionForward, the superclass logBusinessActivityStatus( ) method is called, which calls the TransactionProxy's logErrorCode( ) and logSuccessIndicator( ) methods.

The following use case describes a typical course of events for allowing a service to save extra data to be logged into the business activity log file in key, value pairs.
1. The Controller receives a request to process.
2. Controller creates a TransactionImpl object and does the proper initialization for it. The Controller then creates a TransactionProxy and places it in request scope.
3. Inside a service's action class, if it wishes to add data to the business activity log file, it must extract the TransactionProxy object from the request.
4. After the service has the TransactionProxy object, it calls its logBusinessActivityInfo method, giving it a (key, value) pair. This method stores the data in the BusinessActivityManager.

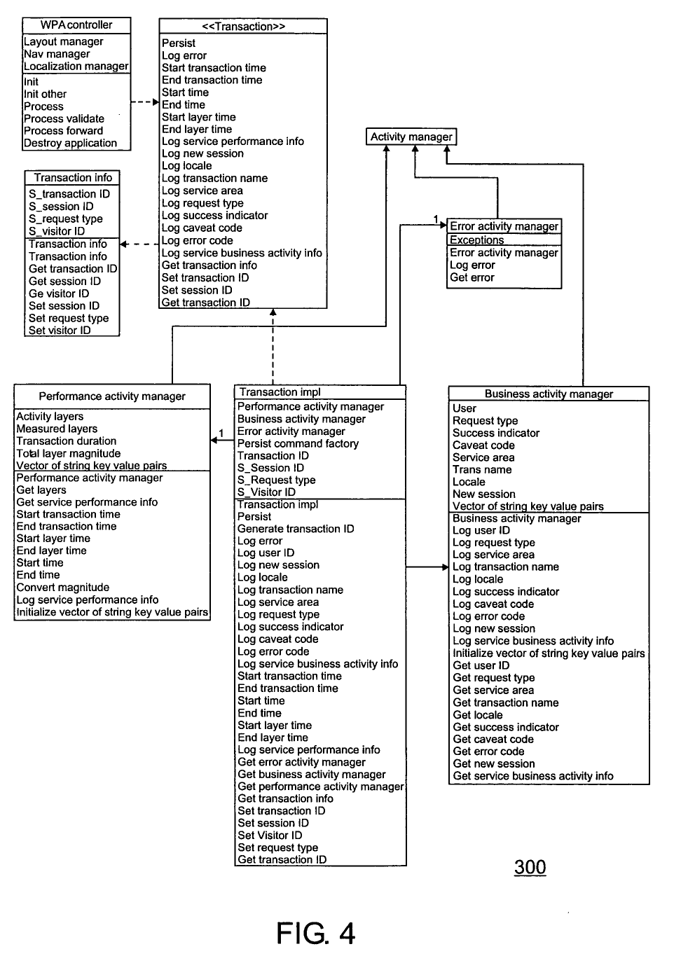

FIG. 4 is an object diagram of an architecture for transaction classes in accordance with embodiments of the present invention. The object model, which does not include the TransactionProxy class, is generally referred to by the reference numeral 300. As set forth above, the Transaction interface relied upon by all clients that publish transaction information. The Transaction interface specifies the methods that subclasses need to define to allow clients to direct data storage and logging.

As shown in FIG. 4, the Transaction object comprises the following methods.
public void persist( )—When concrete, this method may start the logging process.
public void logError(ErrorInfo errorInfo)—This method directs the ErrorActivityManager to store the information related to an exception for use later in logging.
public void startTransactionTime ( )—This method registers the start time for the overall transaction. This method needs to be invoked before any steps are executed to process a request. Typically, the controller should invoke this method as soon as an incoming request is received, before commencing any steps to process the request.
public void endTransactionTime ( )—This method registers the end time for the overall transaction. This method should be invoked by the controller after all steps are executed to process a request.
public void startLayerTime(String p_whereReported)—This method uses the notion of layers that the Controller will have and takes the name of the layer as the parameter. The method starts the timing for the specified layer (e.g., the navigation manager). The parameter may be defined in a known location, such as MetricPoint.java in a \pl\transaction\util directory.
public void endLayerTime(String p_whereReported)—This method uses the notion of layers that the Controller will have and takes the name of the layer as the parameter. The method ends the timing for the specified layer, i.e. the navigation manager. The parameter may be defined in a known location, such as MetricPoint.java in the \pl\transaction\util directory.
public void startTime (Object p_reportingObject, String p_reportingMetric)—This method registers the start time for a performance measurement taken within a layer. Specifically, this call will be used by services for their timing. The reporting object should pass itself using a “this” reference. The reportingMetric is the metric whose start is being reported. For example, this could be the name of a method.
public void endTime (Object p_reportingObject, String p_reportingMetric)—This method registers the end time for a performance method taken within a layer. The reporting object and reporting metric must match those for the startTime call to which a particular endTime call corresponds.
public void logServicePerformanceInfo(String key, String value)—This method adds the String key/String value pair to the performance log record. This method is to be used by services to add service specific information to the performance log record. Multiple invocations of this method will result in multiple key/value pairs being added to the log record with the ordering preserved. The object that ultimately persists the log records will decide on the delimiter to use to delimit multiple key/value pairs, and the separator (such as <code>“=”</code>) to use between the key and the value. Objects invoking this method should not include any delimiter or separator. This method is responsible only for collecting this key/value pair information, and has no control over where or how this information is ultimately persisted.
public void logSuccessIndicator(int successInd)—This method stores the success indicator for the request. The successIndicator indicates the status of the request. The integer parameter passed in should be one of the static final integers defined in the SuccessIndicators class, which may be in an \exception directory. Only the most severe success indicator is logged.
public void logCaveatInfo(CaveatInfo caveatInfo)—This method stores the caveat info object associated with a successful request.
public void logErrorCode(String errorCode)—This method stores the code of the last error encountered. It may not be the same error whose severity is recorded in the successIndicator field.
public void logLocale(String aLocale)—This method stores a string representing the current locale for the user.
public void logServiceBusinessActivityInfo(String key, String value)—This method adds the String key/String value pair to the business activity log record. This method is to be used by services to add service specific information to the business activity log record. Multiple invocations of this method will result in multiple key/value pairs being added to the log record with the ordering preserved. The object that ultimately persists the log records will decide on the delimiter to use to delimit multiple key/value pairs, and the separator (such as <code>“=”</code>) to use between the key and the value. Objects invoking this method should not include any delimiter or separator. This method is responsible only for collecting this key/value pair information, and has no control over where or how this information is ultimately persisted.
public TransactionInfo getTransactionInfo( )—This method should create a new TransactionInfo object and return it for use inside the subclass.
public void setTransactionID(String aTransactionID)—This method should set the transaction ID for use in creating a new TransactionInfo object.
public void setSessionID(String aClientID)—This method should set the session id for use in creating a new TransactionInfo object.
public String getTransactionID( ).—This method returns the transaction ID.

The TransactionImpl object represents an exemplary embodiment of a transaction interface that may be used in an architecture constructed according to embodiments of the present invention. The TransactionImpl object will delegate method calls invoked on it by clients to one of the ActivityManagers, depending on the nature of the method call. It defines all the methods listed above with respect to the Transaction interface, and it may also have additional key methods, as set forth below.
private String generateTransactionID( )—This method generates a unique transaction ID based on the time since Jan. 1, 1970 and a four digit random number.
public void logRedirect(String aPath)—This method stores the redirect path so that the data can be logged in the business activity log file.
private ErrorActivityManager getErrorActivityManager( )—This method returns the ErrorActivityManager pertaining to this TransactionImpl object. The operation of this method allows the creation of the ErrorActivityManager on demand, if needed. It creates the ErrorActivityManager the first time it is accessed.
private BusinessActivityManager getBusinessActivityManager( )—This method returns the BusinessActivityManager pertaining to this TransactionImpl object. The operation of this method allows the creation of the ActivityManager on demand, if needed. It creates the BusinessActivityManager the first time it is accessed.
private PerformanceActivityManager getPerformanceActivityManager( )—This method returns the PerformanceActivityManager pertaining to this TransactionImpl object. The operation of this method allows the creation of the ActivityManager on demand, if needed. It creates the PerformanceActivityManager the first time it is accessed.
public void setRequestType(String requestType)—This method stores the requestType for logging in the business activity log.
public void setClientID(String clientID)—This method stores the client ID for logging in the business activity log.

The TransactionProxy object wraps a Transaction object and limits the methods accessible by services. The WPAController creates a TransactionProxy object and places it in request scope. Services may only have access to the proxy and not the actual Transaction implementation class. The following methods comprise the TransactionProxy object.
public void logError(ErrorInfo errorInfo)—This method calls the logError(ErrorInfo errorInfo) method of the TransactionImpl object.
public void logRedirect(String path)—This method calls the logRedirect(String path) method of the TransactionImpl object.
public void logServiceBusinessActivityInfo(String key, String value)—This method calls the logServiceBusinessActivityInfo(String key, String value) method of the TransactionImpl object.
public void startTime (Object p_reportingObject, String p_reportingMetric)—This method calls the startTime(Object p_reportingObject, String p_reportingMetric) method of the TransactionImpl object.
public void endTime (Object p_reportingObject, String p_reportingMetric)—This method calls the endTime(Object p_reportingObject, String p_reportingMetric) method of the TransactionImpl object.
public void logServicePerformanceInfo(String key, String value)—This method calls the logServicePerformanceInfo(String key, String value) method of the TransactionImpl object.
public void logSuccessIndicator(int successInd)—This method calls the logSuccessIndicator(int successInd) method of the TransactionImpl object.
public void logCaveatInfo(CaveatInfo caveatInfo)—This method calls the logCaveatInfo(CaveatInfo caveatInfo) method of the TransactionImpl object.
public void logErrorCode(String errorCode, int successIndOfCurrException)—This method calls the logErrorCode(String errorCode, int successIndOfCurrException) method of the TransactionImpl object.
public String getTransactionID( )—This method calls the getTransactionID( ) method of the TransactionImpl object and returns the value it receives.
public void setClientID(String id)—This method calls the setClientID(String id) method of the TransactionImpl object.

A web presentation architecture constructed in accordance with embodiments of the present invention may comprise an Activity Manager class of objects. The Activity Manager class may comprise an abstract superclass of all activity manager objects. It must be serializable so it can be passed from one virtual machine (“VM”) to another as part of the TransactionImpl. The Activity Manager class may have no methods.

The Activity Manager class may comprise three concrete subclasses (i.e. a subclass that may have instances or be instantiated rather than inherited) of objects. Those three concrete cubclasses are the BusinessActivityManager, the ErrorActivityManager and the PerformanceActivityManager. The BusinessActivityManager is the concrete subclass of ActivityManager for creating, organizing and managing information related to business activity during a transaction. One purpose of the BusinessActivityManager is to store information and provide it to the PersistBusinessActivityCommand for logging. Each “log<variable>” function stores information into the activity manager. For each such log function, there is a getter function that enables the PersistBusinessActivityCommand to access the information during logging. The following methods may be implemented in the BusinessActivityManager.
public void logRedirect(String aPath)—This method stores the redirect path so that the data can be logged in the business activity log file.
public void logSuccessIndicator(int successInd)—This method stores the success indicator into the business activity manager, if the indicator reflects a more severe status than what is currently stored.
public void logLocale(String alocale)—This method stores a string that reflects a locale into the business activity manager.
public void logCaveatInfo(CaveatInfo aCaveat)—This method stores the CaveatInfo object into the business activity manager.
public void logErrorCode(String errorCode)—This method stores the error code of the most recent error encountered into the business activity manager.
public void logNewSession(String aNewSession)—This method stores information about the HttpRequest into the business activity manager when a session is new.
public void logServiceBusinessActivityInfo(String key, String value)—Services may use this method to add additional information to the business activity log file. The parameters, which may be key, value pairs, may be presented in a key=value format at the end of the log file entry.
public Vector getServiceBusinessActivityInfo( )—This method may function as the getter method for the additional service specified information.
Other corresponding getter functions for each “log<variable>” method—These getter functions are used during logging to access the data stored in order to place it in the log file.

The ErrorActivityManager is the concrete subclass of ActivityManager for creating, organizing and managing information related to error activity during a transaction. The following methods may be implemented in the ErrorActivityManager.
public void logError(ErrorInfo errorInfo)—This method stores an errorInfo object into the activity manager.
public Enumeration getErrors( )—This method returns the stored errorInfo objects as an enumeration for logging purposes.

The PerformanceActivityManager is the concrete subclass of ActivityManager for creating, organizing and managing information related to performance activity during a transaction. The PerformanceActivityManager is discussed in greater detail below. The following methods may be implemented in the PerformanceActivityManager.
public void startTransactionTime ( )—This method registers the start time for a transaction.
public void endTransactionTime ( )—This method registers the overall end time for a transaction.
public void startLayerTime (String p_whereReported)—This method registers the start time for a layer. Where reported is the layer name that will appear next to the performance measurement in the log file.
public void endLayerTime (String p_whereReported)—This method registers the end time for a layer. Where reported is the layer name, and must match the whereReported passed to the startLayerTime for the same layer.
public void startTime (Object p_reportingObject, String p_reportingMetric)—This method registers the start time for a performance measurement that is inside a layer. The reporting object is the object that is taking the measurement, and the reporting metric is what is being measured, for example, this could be the name of a method.
public void endTime (Object p_reportingObject, String p_reportingMetric)—This method registers the end time for an already existing performance measurement that is inside a layer. It is required that the values passed here exactly match the values used for the start time. The reporting object is the object that is taking the measurement, and the reporting metric is what is being measured, for example, this could be the name of a method.
public String convertMagnitude( )—This method will return the String representation of the transaction magnitude. The magnitude may be expressed as a time period, such as seconds.
public void logServicePerformanceInfo(String key, String value)—This method stores service specific data as key, value pairs. This aids in allowing services to add additional data to the end of the performance log file.
public Enumeration getLayers( )—This method returns the layers for the transaction as an enumeration.
public Vector getServicePerformanceInfo( )—This method returns the service specific data stored using the logServicePerformanceInfo( ) method.

The TransactionInfo class holds information pertaining to the entire transaction, such as request type, session ID, visitor ID, and transaction ID. Objects that may be implemented as part of the TransactionInfo class comprise the following.
public TransactionInfo(String aTransactionID, String aSessionID, String aRequestType, String aClientID)—This constructor is for portals that wish to record a visitor id.
Setter/getter methods for all fields.
   Performance Activity Manager

The PerformanceActivityManager may oversee the calculation of performance metrics in architectures constructed in accordance with embodiments of the present invention.

The following actors may be implemented in a performance activity manager constructed in accordance with embodiments of the present invention.
Controller—creates one transaction object per request and stores it in request scope so that services can access it and store data to be logged.
TransactionImpl—the implementation of the transaction interface that directly accesses activity managers and the TransactionInfo object.
PerformanceActivityManager—This object stores information about the performance metrics that will be logged for the transaction. It may also oversee taking the proper measurements.
MetricLayer—This object is the superclass of PerformanceMetricLayer. It keeps a collection of measurements that are being reported and manages this list.
PerformanceMetricLayer—this class oversees the calculation of time for a layer, and also stores and controls each metric within the layer.
Metric—this class combines all the various things that can be measured into one Metric object type. In this manner, many different measurements may be done, each tracked by a specific metric type.
MetricMeasurement—this class oversees the calculation of time for a metric.
Quantity—this is the superclass for all Quantity objects. Each concrete Quantity is responsible for creating appropriate arithmetical and comparative operations.
Duration—this class represents a quantity that has a time duration.

The operation of the performance activity manager functionality provided by embodiments of the present invention may be better understood upon consideration of example use cases relating to various aspects of its operation. Several example use cases, including the typical flow of events for each example, are set forth below.

The following use case describes a typical course of events for gathering time for an overall transaction.
1. The Controller creates a TransactionImpl object each time it processes a new request.
2. The Controller calls the transaction object's startTransactionTime( ) method.
3. The transaction object then calls the PerformanceActivityManager's startTransactionTime( ) method.
4. The PerformanceActivityManager's startTransactionTime( ) method calls the start( ) method on a Duration object, storing the start time in that object.
5. After the controller is finished processing the request, it calls the transaction object's endTransactionTime( ) method.
6. The transaction object then calls the PerformanceActivityManager's endTransactionTime( ) method.
7. The PerfommanceActivityManager's endTransactionTime( ) method calls the stop( ) method on the Duration object. This stores the end time and calculates the duration.

The following use case describes a typical course of events for gathering time for a layer within the transaction.
1. The Controller creates a TransactionImpl object each time it processes a new request.
2. The Controller calls the transaction object's startLayerTime(<layer name>) method and passes it the name of the layer.
3. The tranasaction's startLayerTime( ) method calls startLayerTime( ) of the PerformanceActivityManager.
4. In the PerformanceActivityManager, the startLayerTime(<layer name>) method creates a new PerformanceMetricLayer and calls its startTime( ) method it. That startTime( ) method calls start( ) on a Duration object, storing the start time in that object.
5. After the controller is finished processing the request, it calls the transaction object's endLayerTime( ) method, which calls the PerformanceActivityManager's endLayerTime( ) method. The PerformanceActivityManager then grabs the PerformanceMetricLayer object pertaining to the layer and calls its endTime( ) method, which in turn calls stop( ) on a Duration object.
6. The stop( ) method on the Duration object stores the end time and calculates the duration.

The following use case describes a typical course of events for gathering time for a metric within a layer.
1. Within a layer, a service must access the transaction object from the request.
2. The service then calls the transaction object's startTime(Object p_reportingObject, String p_reportingMetric) method, where reportingObject is “this”, and reportingMetric is a description of the block of code being measured, such as a method name.
3. The startTime( ) method calls the PerformanceActivityManager's startTime( ), which accesses the current PerformanceMetricLayer and creates a new Duration, Metric, and MetricMeasurement.
4. The Duration is started, then stored in the MetricMeasurement.
5. The service calls the transaction's endTime(Object p_reportingObject, String p_reportingMetric) method. This calls the PerformanceActivityManager's endTime( ), which gets the right MetricMeasurement from the current PerformanceMetricLayer and calls the stop( ) method on the Duration object.
6. The stop( ) method on the Duration object stores the end time and calculates the duration.

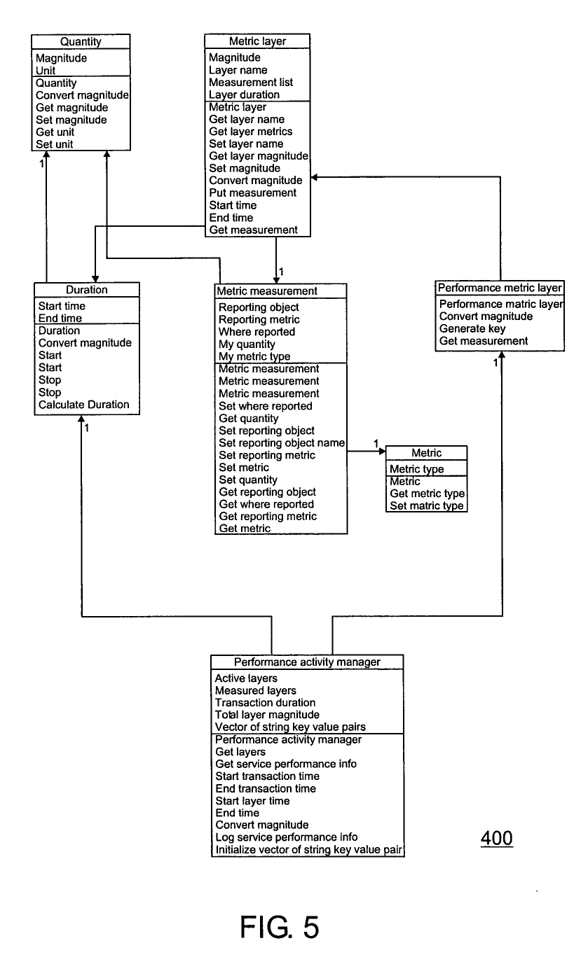

FIG. 5 is an object diagram of an architecture for a performance activity manager in accordance with embodiments of the present invention. The object model is generally referred to by the reference numeral 400. The PerformanceActivityManager may be a concrete subclass of ActivityManager for creating, organizing and managing information related to performance activity during a transaction. The PerformanceActivityManager may comprise the following objects.
public void startTransactionTime ( )—This method registers the start time for a transaction.
public void endTransactionTime ( )—This method registers the overall end time for a transaction.
public void startLayerTime (String p_whereReported)—This method registers the start time for a layer. WhereReported is the layer name that will appear next to the performance measurement in the log file.
public void endLayerTime (String p_whereReported)—This method registers the end time for a layer. Where reported is the layer name, and must match the whereReported passed to the startLayerTime for the same layer.
public void startTime (Object p_reportingObject, String p_reportingMetric)—This method registers the start time for a performance measurement that is inside a layer. The reporting object is the object that is taking the measurement, and the reporting metric is what is being measured, for example, this could be the name of a method.
public void endTime (Object p_reportingObject, String p_reportingMetric)—This method registers the end time for an already existing performance measurement that is inside a layer. It is required that the values passed here exactly match the values used for the start time. The reporting object is the object that is taking the measurement, and the reporting metric is what is being measured, for example, this could be the name of a method.
public String convertMagnitude( )—This method will return the String representation of the transaction magnitude. It may be adapted to return the magnitude in units of seconds.
public void logServicePerformanceInfo(String key, String value)—This method stores service specific data as key, value pairs. This aids in allowing services to add additional data to the end of the performance log file.
public Enumeration getLayers( )—This method returns the layers for the transaction as an enumeration.
public Vector getServicePerformanceInfo( )—This method returns the service specific data stored using the logServicePerformanceInfo( ) method.

The next class to be discussed is the MetricLayer class. The MetricLayer class tracks the total magnitude measured in this layer by keeping a collection of measurements that are being reported and managing this list. The following methods may be implemented in the MetricLayer class.
protected MetricLayer (String p_layerName)—This is the constructor for MetricLayer. The parameter is the name of the layer.
public void startTime( )—This method sets the start time for the layer.
public void endTime( )—This method sets the end time for the layer.
public String getLayerName( )—This method returns the name of the layer.
public Enumeration getLayerMetrics( )—This method returns the list of measurements taken in this layer.
public long getLayerMagnitude( )—This method returns the overall magnitude measured in the layer.
public void setMagnitude(long p_magnitude)—This method sets the magnitude measured in the layer.
public abstract String convertMagnitude( )—This abstract method is responsible for converting the overall magnitude measured in the layer to a string.
public void putMeasurement(Object p_key, MetricMeasurement p_measurement)—This method adds a new measurement that is being done in the layer to the list.
public abstract MetricMeasurement getMeasurement(Object reportingObject, String p_reportingMetric)—This method returns a MetricMeasurement given what the measurement is. It returns null if the measurement cannot be found. Actual implementation must be done through the derived class. The reporting object is the object that is conducting the measurement, while the reporting metric is what is being measured.

The next class to be discussed is the MetricLayer class. This class extends MetricLayer. It registers the layer that the metric is being taken in and tracks the total time spent in the layer. The MetricLayer class may comprise the following methods.
public PerformanceMetricLayer (String p_layerName)—The constructor for PerformanceMetricLayer takes in a layer name as its parameter.
public String convertMagnitude( )—This method returns the overall time spent in the layer (in seconds).
public String generateKey(Object p_reportingObject, String p_reportingMetric)—This method generates the key that will be applied to performance measurements. For performance measurements the key is the concatenation of the reporting object name (derived from the object) and what is being reported (the reporting metric).
public MetricMeasurement getMeasurement(Object p_reportingObject, String p_reportingMetric)—This method returns a MetricMeasurement given a reporting object and a reporting metric, where the reporting object is the object that is conducting the measurement and the reportingMetric is what is being measured. Null is returned if the MetricMeasurement cannot be found.

The next class to be discussed is the Metric class. This class combines all the various things that can be measured into one Metric object type. This way there can be many different measurements done, each tracked by a specific metric type. Here, a metric is what is being measured. The following methods may be implemented by the Metric class.
public Metric (String p_metricType)—The constructor for Metric whose parameter is the specific metric type.
public String getMetricType( )—This method returns the metric type for this measurement. If the metric type was incorrectly set, the value will be “unknown.”

The next class to be discussed is the MetricMeasurement class. This class captures what is being measured, who is doing the measurement and where the measurement is being taken. The methods that may be implemented in the MetricMeasurement class comprise the following.
public MetricMeasurement (Object p_reportingObject, String p_reportingMetric, String p_whereReported)—This constructor allows for the object that is doing the measurement to pass itself into the MetricMeasurement. The reporting object is the object that is taking the measurement, the reporting metric is a string description of what is being measured (i.e. a method name), and where reported is where the measurement is being taken (in architectures constructed in accordance with the embodiments of the present invention, this may be the name of the layer).
public MetricMeasurement (String p_reportingObject, String p_reportingMetric, String p_whereReported)—This constructor allows for the object that is doing the measurement to pass itself into the MetricMeasurement via object.getClass( ).getName( ). The reporting object name is the name of the object that is taking the measurement. The reporting metric is a description of what is being measured, such as a method name. WhereReported is where the measurement is being taken (in architectures constructed in accordance with the embodiments of the present invention, this may be the name of the layer).
public void setWhereReporteD(String p_whereReported)—This method sets the where the measurement was taken. In architectures constructed in accordance with embodiments of the present invention, this may be the name of a layer. It is defaulted to “unknown” if the parameter passed in is null or an empty string.
public Quantity getQuantity( )—This method returns the quantity associated with this measurement. If incorrectly set, the quantity will be null.
public void setMetric(Metric p_metricType)—This method sets the type of this metric measurement.
public void setQuantity(Quantity p_quantity)—This method sets the quantity that is being measured.
public String getReportingObject( )—This method returns the object that conducted the measurement. If incorrectly set the value will be “unknown”.
public String getWhereReported( )—This method returns where the measurement was taken. In architectures constructed in accordance with embodiments of the present invention, this may be the name of a layer. If incorrectly set the value will be “unknown”.
public String getReportingMetric( )—This method returns what was being measured. If incorrectly set the value will be “unknown”.
public Metric getMetric( )—This method returns the metric type for this measurement. If incorrectly set the value will be null.

The Quantity superclass is the abstract superclass for all Quantity objects. Each concrete Quantity is responsible for creating appropriate arithmetical and comparative operations. The Quantity maintains a magnitude and unit, thus allowing it to maintain quantities of any type. The Quantity superclass may implement the following methods.
public abstract String convertMagnitude( )—This abstract method will return the String representation of the magnitude. The actual implementation of this method will need to calculate/convert the magnitude to String.
public long getMagnitude( )—This method returns the magnitude.
protected void setMagnitude(long p_magnitude)—This method sets the magnitude.
public String getUnit( )—This method returns the unit value associated with the magnitude (i.e. feet, seconds, height).
protected void setUnit(String p_unit—This method sets the unit associated with the magnitude.

The Duration class represents a quantity that has a time duration where the magnitude is the overall time and the unit is seconds. The Duration class may implement the following methods.
public String convertMagnitude( )—This method returns the String representation of the magnitude. The magnitude may first be converted into seconds.
public void start( )—This method sets the start time value for this duration.
public void start(long p_startTime)—This method sets the start time value for this duration to the startTime that is received.
public void stop( )—This method sets the end time value for this duration and also sets the magnitude for this duration.
public void stop(long p_endTime)—This method sets the end time value for this duration to the time passed in. It may also set the magnitude for this duration.
public long calculateDuration( )—This method calculates the duration of this quantity.
   Logging Design

The following discussion relates to logging design. Web presentation architectures constructed in accordance with embodiments of the present invention may provide six types of logs: business activity, performance activity, error, error trace, debug, and startup error. Those of ordinary skill in the art will appreciate that these log types are given for purposes of illustration only. Other log types may be implemented in addition to or instead of one or more of the above-identified log types. Additionally, logs may be divided into two further subcategories. The first subcategory of logs is transaction logs, which store data in activity managers, then write the data when persist commands are called. The second subcategory of logs is logs that do not depend on activity managers or persist commands.

Transaction logging may comprise the two actions of gathering data and writing the data to the proper log file. Architectures constructed in accordance with embodiments of the present invention may use a Transaction object to gather data in activity managers. That transaction data may be written to log files at the end of the transaction with persist commands. The business activity, performance activity, error, and error trace logs are all transaction logs. Other log files, such as the debug and the startup error files, are written to on an as-needed basis, and do not necessarily require data storage.

Services may write directly to the debug log and the startup error log. In addition, services may also log to the business, error, and performance logs using key/value pairs (see the description of the Transaction class method below). Architectures constructed in accordance with embodiments of the present invention may support commercially available logging programs to perform actual logging. The LogController class may be called during the configuration phase of Controller startup to set up each log file. The WPALog controls the logging threads. Such threads are set to a low priority to enhance the performance of the process. Debug, StartupError, and optional service logging may be controlled by the Log class. This is done so that each new entry to any of those logs occurs as soon as the command is called to facilitate debugging.

The following actor objects may be implemented to facilitate logging in web presentation architectures according to embodiments of the present invention.
Controller—creates one transaction object per request and stores it in request scope so that services can access it and store data to be logged.
Transaction interface—the interface on which all clients (objects that publish information) rely on. The TransactionImpl (which implements this) gets the persist commands for the activity managers, and when its execute( ) method is called, the logging starts.
PersistCommandConfigurator—This class is one of the configuration classes called during the configuration phase of Controller startup.
PersistCommand—this is the abstract superclass of all the persist commands. This class is analogous to the Command superclass in the Command pattern. In the current context, each Command object may be responsible for interacting with a specific ActivityManager to extract the information to be persisted, format the information and persist it.
PersistErrorLogsCompositeCommand—this class controls the transaction error logging. For each exception stored in the ErrorActivityManager, it calls the PersistErrorLogCommand, and, if necessary, calls the PersistErrorTraceCommand, as well.
PersistErrorLogCommand—this class extracts data from the ErrorActivityManager and uses it to create the entries in the error log file.
PersistErrorTraceCommand—This class extracts date from the ErrorActivityManager and uses it to create the entries in the error trace log file.
PersistBusinessActivityCommand—this class extracts data from the BusinessActivityManager and uses it to create and log the entries in the business activity log file.
PersistPerformanceLogCommand—this class extracts data from the PerformanceActivityManager and uses it to create and log the entries in the performance activity log file.
AbstractHandlerFactory—Concrete instances of this class manage a dynamic list of handlers for an object. All Factory classes should extend this abstract superclass. Each of these Factory objects behaves like a singleton collection and is responsible for returning an appropriate object based on a key. This is possible because each factory maintains a mapping that translates a key to an appropriate handler object. A singleton collection is a collection of objects that are defined at initialization and may be accessible to a variety of objects in the web application at run time.
PersistCommandFactory—This is a singleton collection that is responsible for mapping an ActivityManager to an appropriate subclass of com.hp.bco.pl.transaction.persistcommand.PersistCommand.
WPALog—This class oversees Transaction logging.
Log—This class controls debug, startupError, and optional service logging. Each new entry to any of those logs is logged as the command is encountered rather than saved and logged all at once, as occurs with the Transaction logs.
LogController—This class is one of the configuration classes called during the configuration phase of WPAController startup. Each log file is configured during this time.

The operation of the logging functionality provided by embodiments of the present invention may be better understood upon consideration of example use cases relating to various logging events. Several example use cases, including the typical flow of events for each example, are set forth below.

The following use case describes a typical course of events for a logging sequence in which involves debug logging.
1. During the configuration phase in Controller, the LogConfigurator.configure( ) method is called.
2. Within the configure( ) method, the configureDebugLogger( ) method is called, which creates a new TimeRolloverLog that is loaded into Syslog.
3. After that, any time a developer needs to output to the debug log, the static method logDebug(Object className, Object serviceName, String message) should be used. The call therefore resembles the following: Log.logDebug(this, “WPAframework”, “About to call activity manager method”).
4. The Log.logDebug( ) method makes a call to the logging program, passing it the debug logger, the channel name, the className object, and the message to be logged, and the entry is logged.

The following use case describes a typical course of events for a sequence relating to startup exception logging. The logger used to write to the startupErrorLog may be initialized the first time the logStartupError method from the Log class is called. Because a startup exception may occur before the LogConfigurator has run, the method first checks if the logger exists and creates it if it does not.
1. A call to Log.logStartupError(Object className, Object serviceName, String message) is made, where className is the current object, serviceName is the service, and message is the message to be logged.
2. logStartupError( ) checks to see if a logger for the startupErrorLog has been created. If not, it creates a new LogConfigurator and uses it to configure one.
3. Syslog.infoToChannel( ) is then called, and is passed the startupErrorLog logger, the startup log channel name, the className object, and the message to be logged. Syslog then logs the entry.

The following use case describes a typical course of events for a sequence relating to a transaction logging error. Embodiments of the present invention may implement two types of error log files: error log files and error trace log files. The error log file may contain log information about the topmost error, i.e. the error thrown to an action class and passed to a concrete subclass of ErrorActionForward. The error trace log file may contain log information relating to the entire exception sequence of an exception. This means that if an exception was caused by one or more other exceptions, the trace of this sequence is logged in the error trace log.
1. During the configuration phase of Controller startup, the PersistCommandConfigurator is run.
2. After the PersistCommandConfigurator is done loading the PersistCommandMapper, it gets an instance of the singleton object PersistCommandFactory, then calls its configure( ) method.
3. For each key,value pair in the PersistCommandMapper, the value(the fully qualified name of a persist command class) is used to create an instance of that command.
4. This new instance is then stored in the PersistCommandMapper, with the fully qualified name of its corresponding activity manager serving as the key.
5. Controller creates a transaction object when it receives a new request.
6. The transaction object gets an instance of the singleton PersistCommandFactory object, which will be used later to get the correct persist command for logging.
7. Controller processes the request, and along the way, if a system error occurs, calls are made to the transaction object that stores the data into the ErrorActivityManager.
8. Controller finishes processing the request, so it calls WPALog.logTransaction. This creates a new WPALoggingThread and sets it to minimum priority.
9. When the thread executes, it calls the transaction's persist( ) method. Error logging may be processed first.
10. For error logging, the transaction object obtains the ErrorActivityManager.
11. The transaction then obtains a PersistErrorLogsCompositeCommand by passing the ErrorActivityManager to its PersistCommandFactory instance.
12. The transaction sets the activity manager and transaction info in the persist command, then calls the command's execute( ) method.
13. The PersistErrorLogsCommand's execute( ) method creates a new PersistErrorLogCommand and calls its execute( ) method. That execute method uses the ErrorActivityManager and the TransactionInfo object to get the transaction and error data. It creates a StringBuffer with all the data, then passes it to the static method logActivity( ).
14. The logging program is passed the string and logs the entry to the error log file.
15. The PersistErrorLogsCommand then checks if any of the exceptions stored in the ErrorActivityManager were the result of other exceptions. If so, it creates a PersistErrorTraceCommand and calls its execute( ) method. That execute method uses the ErrorActivityManager and the TransactionInfo object to get the transaction and error data. It creates a StringBuffer with all the data, then passes it to the static method logActivity( ).
16. The logging program is passed the string and logs the entry to the error trace log file.
17. Control returns to the transaction object, and it continues processing, logging business activity data, then performance activity data.

The following use case describes a typical course of events for a sequence relating to transaction logging for business activity.
1. During the configuration phase of Controller startup, the PersistCommandConfigurator is run.
2. After the PersistCommandConfigurator is done loading the PersistCommandMapper, it gets an instance of the singleton object PersistCommandFactory, then calls its configure( ) method.
3. For each key,value pair in the PersistCommandMapper, the value(the fully qualified name of a persist command class) is used to create an instance of that command.
4. This new instance is then stored in the PersistCommandMapper, with the fully qualified name of its corresponding activity manager serving as the key.
5. WPAController creates a transaction object when it receives a new request.
6. The transaction object gets an instance of the singleton PersistCommandFactory object, which will be used later to get the correct persist command for logging.
7. Controller processes the request, and along the way, calls are made to the transaction object that store data into the BusinessActivityManager.
8. Controller finishes processing the request, so it calls WPALog.logTransaction. This creates a new WPALoggingThread and sets it to minimum priority.
9. When the thread executes, it calls the transaction's persist( ) method. Error logs may be processed first.
10. For Business Activity Logging, the transaction object may obtain the BusinessActivityManager.
11. The transaction then obtains a PersistBusinessActivityCommand by passing the BusinessActivityManager to its PersistCommandFactory instance.
12. The transaction sets the activity manager and transaction info in the persist command, then calls the command's execute( ) method.
13. The PersistBusinessActivityCommand's execute( ) method uses the BusinessActivityManager and the TransactionInfo object to get the transaction and business activity data. It creates a StringBuffer with all the data, then passes it to the static method logActivity( ).
14. The logging program is passed the string and logs the entry to the business activity log file.
15. Control returns to the transaction object, and it continues processing, logging performance activity data.

The following use case describes a typical course of events for a sequence relating to transaction logging for performance activity.
1. During the configuration phase of Controller startup, the PersistCommandConfigurator is run.
2. After the PersistCommandConfigurator is done loading the PersistCommandMapper, it gets an instance of the singleton object PersistCommandFactory, then calls its configure( ) method.
3. For each key,value pair in the PersistCommandMapper, the value(the fully qualified name of a persist command class) is used to create an instance of that command.
4. This new instance is then stored in the PersistCommandMapper, with the fully qualified name of its corresponding activity manager serving as the key.
5. Controller creates a transaction object when it receives a new request.
6. The transaction object gets an instance of the singleton PersistCommandFactory object, which will be used later to get the correct persist command for logging.
7. Controller processes the request, and along the way, calls are made to the transaction object that store data into the PerformanceActivityManager.
8. Controller finishes processing the request, so it calls WPALog.logTransaction. This creates a new WPALoggingThread and sets it to minimum priority.
9. When the thread executes, it calls the transaction's persist( ) method. Error logs may be processed prior to the business activity log and the performance activity log.
10. For Performance Activity Logging, the transaction object obtains the PerformanceActivityManager.
11. The transaction then obtains a PersistPerformanceLogCommand by passing the PerformanceActivityManager to its PersistCommandFactory instance.
12. The transaction sets the activity manager and transaction info in the persist command, then calls the command's execute( ) method.
13. The PersistPerformanceCommand's execute( ) method uses the PerformanceActivityManager and the TransactionInfo object to get the transaction and performance activity data. It creates a StringBuffer with all the data, then passes it to the static method logActivity( ).
14. The logging program is passed the string and logs the entry to the performance log file.

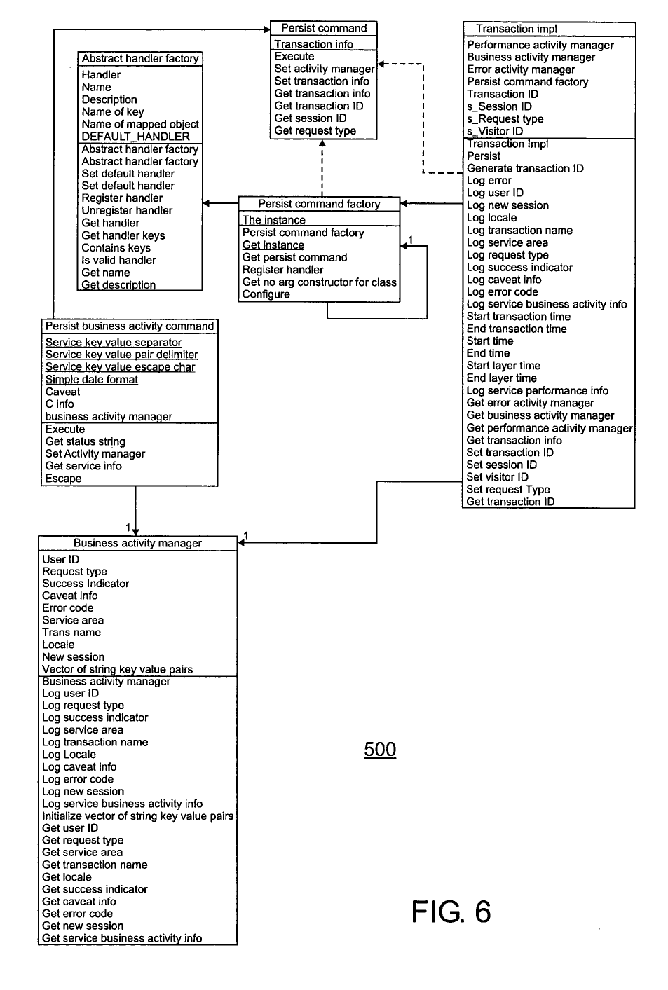

FIG. 6 is an object model diagram illustrating the relationship of the TransactionImpl object with activity managers and persist commands in accordance with embodiments of the present invention. The diagram is generally referred to by the reference numeral 500. For readability, only one activity manager/persist command set is illustrated in FIG. 6. The TransactionImpl uses the PersistCommandFactory, so it has knowledge only of a persist command, and not of any persist command subclasses. However, TransactionImpl does have knowledge of each activity manager. Each persist command depends on a specific activity manager, also, so that it can extract data from it for logging.

The following methods may be implemented.
PersistCommand—This is the abstract superclass of all PersistCommand objects. This class is analogous to the Command superclass in the Command pattern. In the current context, each Command object is responsible for interacting with a specific ActivityManager to extract the information to be persisted, format the information and persist it.
public abstract void execute( )—This is the method that is invoked to get the command to persist the activity records to a persistence store. A persistence store may be a file, a database or another persistence store (e.g. an SNMP listener or the like).
public abstract void setActivityManager(ActivityManager aActivityManager)—This method should be invoked by the object that instantiates this Command object. This method is used to set a reference to the ActivityManager with which this Command object needs to interact. This method must be invoked before the execute method is invoked.
public void setTransactionInfo(TransactionInfo aTransactionInfo)—This method should be invoked by the object that instantiates this Command object. This method is used to set a TransactionInfo object containing information pertaining to the entire transaction. This method must be invoked before the execute method is invoked.
public TransactionInfo getTransactionInfo( )—This method returns the TransactionInfo object associated with this Command object. This TransactionInfo object contains information pertaining to the entire transaction.
public String getTransactionID( )—This method returns the TransactionID contained in the TransactionInfo object associated with this Command object. This is a convenience method provided here for the convenience of subclasses to get at the current TransactionID.
public String getSessionID( )—This method returns the SessionID contained in the TransactionInfo object associated with this Command object. This is a convenience method provided here for the convenience of subclasses to get at the current SessionID.
public String getRequestType( )—This method returns the RequestType contained in the TransactionInfo object associated with this Command object. This is a convenience method provided here for the convenience of subclasses to get at the current RequestType.
PersistBusinessActivityCommand—This Command object is responsible for interacting with the BusinessActivityManager class and logging the business activity log file in the appropriate format to the appropriate Log channel.
public void execute( )—This is the method that extracts data from the BusinessActivityManager and formats it correctly to be output. Persistence may be performed to a log file.
public void setActivityManager(ActivityManager aBusinessActivityManager)—This method is used to set a reference to the ActivityManager with which this Command object needs to interact with, in this case, the BusinessActivityManager. This method must be invoked before the execute method is invoked.
   PersistErrorLogsCompositeCommand.
PersistErrorLogCommand—This Command object is responsible for interacting with the ErrorActivityManager class and logging the error log file in the appropriate format to the appropriate Log channel.
public void execute( )—This is the method that extracts data from the ErrorActivityManager and formats it correctly to be output. This persists information about the topmost error caught by a framework in accordance with embodiments of the present invention or an action class of a service. Information may be placed into a log file.
public void setActivityManager(ActivityManager aErrorActivityManager)—This method is used to set a reference to the ErrorActivityManager with which this Command object needs to interact. This method must be invoked before the execute method is invoked.
   PersistErrorTraceCommand.
public void execute( )—This is the method that extracts data from the ErrorActivityManager and formats it correctly to be output. It persists information about the series of exceptions leading to the topmost error caught by a framework in accordance with embodiments of the present invention or an action class of a service. Information may be placed into a log file.
public void setActivityManager(ActivityManager aErrorActivityManager)—This method is used to set a reference to the ErrorActivityManager with which this Command object needs to interact with. This method must be invoked before the execute method is invoked.
   PersistPerformanceLogCommand.
public void execute( )—This is the method that extracts data from the PerformanceActivityManager and formats it correctly to be output. This persists information about the performance metrics of the transaction. Information may be placed into a log file.
public void setActivityManager(ActivityManager aPerformanceActivityManager)—This method is used to set a reference to the PerformanceActivityManager with which this Command object needs to interact. This method must be invoked before the execute method is invoked.
AbstractHandlerFactory—This class manages a dynamic list of handlers for some sort of object. All Factory classes (PersistCommandFactory, etc. should extend this abstract superclass. Each of these Factory objects may behave like a singleton and may be responsible for returning an appropriate object based on a key. Each Factory maintains a mapping that translates a key to an appropriate handler object.
public void setDefaultHandler(Object h)—This method sets a default handler for this manager. If no other handler can be found, this handler will be returned. If there is no default handler registered, then null is returned.
public void registerHandler (String key, Object handler)—This method registers a handler under the named key.
public Object unRegisterHandler (String key)—This method un-registers a handler. It returns the old handler or null if there was no handler.
public Enumeration getHandlerKeys( )—This method returns a list of the keys that are currently registered.
PersistCommandFactory—The PersistCommandFactory is a singleton that is responsible for mapping an ActivityManager to an appropriate subclass of transaction.persistCommand.PersistCommand. This PersistCommand may then be used to interpret the transaction information contained in the ActivityManager and persist it in the appropriate format to the appropriate location (e.g. a file, a database, an SNMP listener or the like).
private PersistCommandFactory( )—The default constructor is private because the class is a singleton. It may be undesirable to allow other classes to be able to create new instances.
public synchronized static PersistCommandFactory getInstance( )—This method implements a singleton. Clients get a reference to the factory by calling PersistCommandFactory pcf=PersistCommandFactory.getInstance( ).
public PersistCommand getPersistCommand (String aActivityManager) throws NoSuitablePersistCommandException—This is the main service provided by the PersistCommandFactory. It creates a new PersistCommand object based on the type of ActivityManager.
public synchronized void registerHandler(String key, String handlerName) throws RegisterHandleException—This method is a convenience method to register by name of class rather than class object.
public void configure(ActionServlet servlet)—This method registers the persist commands with the persist command factory.

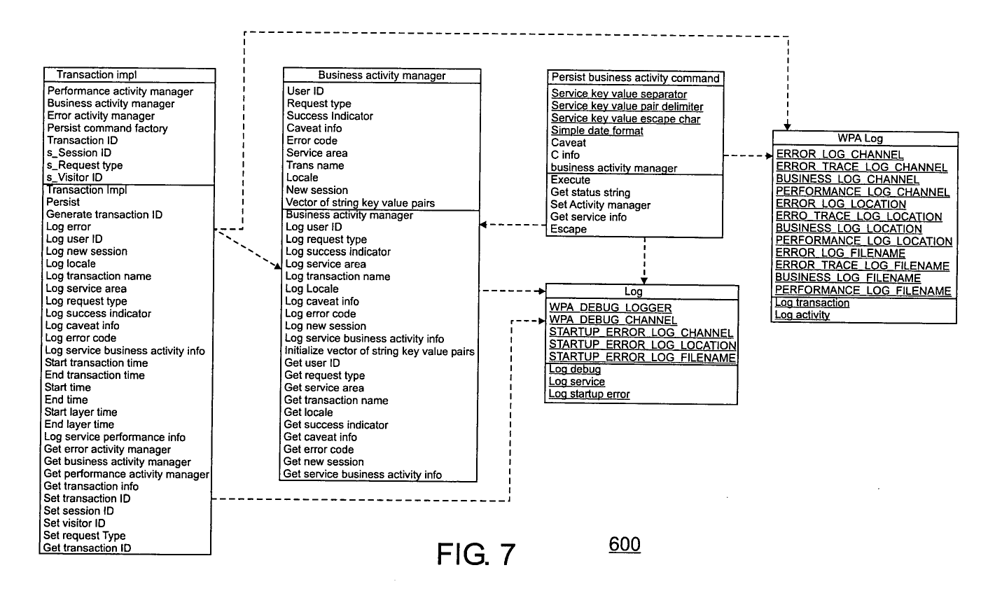

FIG. 7 is an object model diagram illustrating logging classes in accordance with embodiments of the present invention. The diagram is generally referred to by the reference numeral 600. For clarity, only one activity manager/persist command set is illustrated in FIG. 7. Each class may use debug logging, so lines are shown from each class to the Log class, which contains static methods to add entries to both the debug and startup log files. To add entries to the transaction log files, each persist command uses the WPALog, and to start the actual logging, the TransactionImpl may also use the WPALog.

The following objects may be implemented.
WPALog—This class oversees logging for the transaction logs. Each persist command logs its information through a call to the static WPALog.logActivity( ) method. Logging is started when the Controller calls WPALog.logTransaction( ).
public static void logTransaction(Transaction transaction)—This static method takes a transaction object and puts it in a thread to unwind to the various logs. The thread will have a minimal priority to minimize processing time for logging.
public static void logActivity(Object logKey, String channelName, String message){—This static method logs an entry received from a valid object to the specified channelName. The channelName is a static define located in the WPALog class.
Log—This class oversees logging to the debug log file and the startup error log file. The Log class may comprise the following methods.
public static void logDebug(Object className, Object serviceName, String message)—This method logs an entry to the debug logger.
public static void logStartupError(Object className, Object serviceName, String message)—This method logs an entry to the startup class error logger. The logger used to write to the startupErrorLog is initialized the first time this method is called. This log method is special because there is a chance that the LogConfigurator may not have run yet. Because of this, the logStartupError method will check if the logger exits and create it if it does not.
LogController—This class is one of the configuration classes called during the configuration phase of Controller startup. Each log file is configured during this time. For more information about the configuration design, please refer to the Configuration Design Document.
public void configure(ActionServlet servlet)—This sets up a debug log and a usage log.
public Vector getAllLogsToConfigure( ) throws Exception—This method will return a vector of vectors containing configuration information for each log to be configured.

public Vector getStartupErrorLogParameters( ) throws Exception—This method returns a vector containing a hashtable of configuration information for the StartupErrorLog. A vector is returned as to be consistent with other log info methods of the class. The hashtable may contain the following information:

| key | value |
|---|---|
| FILENAME | String - The filename of the log file |
| CHANNEL_NAME | String - The channel name |
| | associated with the log. |

public Vector getMainLogs( ) throws Exception—This method is responsible for building hashtables containing information used to configure the logs. It returns a vector of hashtables containing this info per log. The hashtables may contain the following information:

| key | value |
|---|---|
| FILENAME | String - The filename of the log file |
| CHANNEL_NAME | String - The channel |
| | name associated with the log. |

public void configureChannelLoggers(Vector logVector) throws Exception—This method is responsible for creating channel loggers based upon the configuration information received (passed in). The input may be a vector of hashtables that contain the configuration information. The hashtable may contain the following information:

| key | value |
|---|---|
| CHANNEL_NAME | String - The channel |
| | name registered with syslog |
| FILENAME | String - The filename for the log. |

public void configureDebugLogger( )—This method handles configuration of the Debug Logger.

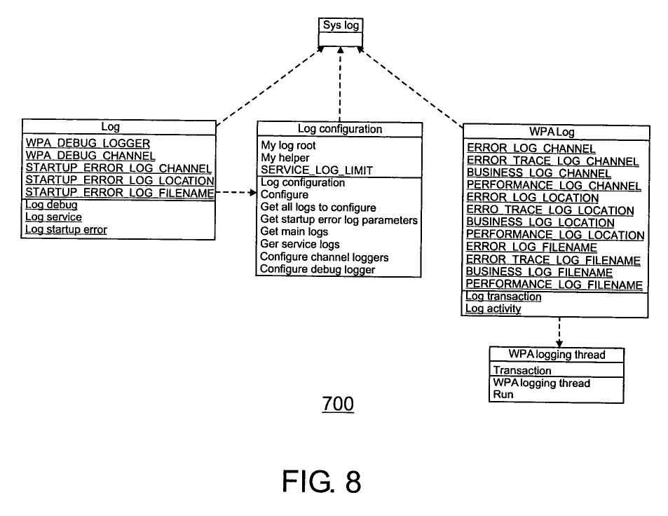

FIG. 8 is an object model diagram illustrating the relationship between the logging configuration class and the log classes in accordance with embodiments of the present invention. The diagram is generally referred to by the reference numeral 700.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A presentation architecture for creating applications, the presentation architecture comprising:
a controller generator that is adapted to provide an application with a controller that receives a request to perform a transaction and completes the transaction in part, by responding to the request; and
transaction tracking logic that is adapted to provide the application with a plurality of transaction managers, each transaction manager being adapted to record tracking information about transactions of a specific type.

2. The system set forth in claim 1, wherein the plurality of transaction managers comprises a business activity manager.

3. The system set forth in claim 1, wherein the plurality of transaction managers comprises a performance activity manager.

4. The system set forth in claim 1, wherein the plurality of transaction managers comprises an error activity manager.

5. The system set forth in claim 1, wherein the transaction tracking logic is adapted to provide the application with the ability to track debug activity.

6. The system set forth in claim 1, wherein the transaction tracking logic is adapted to provide the application with the ability to interface with a logging program to log data collected by the business activity manager, the performance activity manager and the error activity manager.

7. The system set forth in claim 1, wherein the transaction tracking logic is adapted to provide the application with the ability to output data to at least one of a file system, a database, publishing a messaging queue and a Simple Network Management Protocol (“SNMP”)-based monitoring program.

8. The system set forth in claim 1, wherein the tracking information comprises timing measurements with respect to the transaction.

9. A method of creating applications, the method comprising:
creating, with a processor-based device, a controller that receives a request to perform a transaction and completes the transaction by responding to the request; and
providing a plurality of transaction managers, each transaction manager being adapted to record tracking information about transactions of a specific type.

10. The method set forth in claim 9, comprising defining one of the plurality of transaction managers to be a business activity manager.

11. The method set forth in claim 9, comprising defining one of the plurality of transaction managers to be a performance activity manager.

12. The method set forth in claim 9, comprising defining one of the plurality of transaction managers to be an error activity manager.

13. The method set forth in claim 9, comprising providing the application with the ability to track debug activity.

14. The method set forth in claim 9, comprising providing the application with the ability to interface with a logging program to facilitate the logging of data collected by the business activity manager, the performance activity manager and the error activity manager.

15. The method set forth in claim 9, comprising providing the application with the ability to output data to at least one of a file system, a database, publishing a messaging queue and a Simple Network Management Protocol (“SNMP”)-based monitoring program.

16. The method set forth in claim 9, comprising defining the tracking information to comprise timing measurements with respect to the transaction.

17. A system for creating applications, the system comprising:
means for providing an application with a controller that receives a request to perform a transaction and completes the transaction by responding to the request; and
means for providing the application with a plurality of transaction managers, each transaction manager being adapted to record tracking information about transactions of a specific type.

18. The system set forth in claim 17, wherein the plurality of transaction managers comprises a business activity manager.

19. The system set forth in claim 17, wherein the plurality of transaction managers comprises a performance activity manager.

20. The system set forth in claim 17, wherein the plurality of transaction managers comprises an error activity manager.

21. The system set forth in claim 17, wherein the means for providing the application with a plurality of transaction managers is adapted to provide the application with the ability to track debug activity.

22. The system set forth in claim 17, wherein the means for providing the application with a plurality of transaction managers is adapted to provide the application with the ability to interface with a logging program to log data collected by the business activity manager, the performance activity manager and the error activity manager.

23. The system set forth in claim 17, wherein the transaction tracking logic is adapted to provide the application with the ability to output data to at least one of a file system, a database, publishing a messaging queue and a Simple Network Management Protocol (“SNMP”)-based monitoring program.

24. The system set forth in claim 15, wherein the tracking information comprises timing measurements with respect to the transaction.

25. A program, comprising:
a machine readable medium;
a controller generator stored on the machine readable medium, the controller generator being adapted to provide an application with a controller that receives a request to perform a transaction and completes the transaction by responding to the request; and
transaction tracking logic stored on the machine readable medium, the transaction tracking logic being adapted to provide the application with a plurality of transaction managers, each transaction manager being adapted to record tracking information about transactions of a specific type.

26. The program set forth in claim 25, wherein the plurality of transaction managers comprises a business activity manager.

27. The program set forth in claim 25, wherein the plurality of transaction managers comprises a performance activity manager.

28. The program set forth in claim 25, wherein the plurality of transaction managers comprises an error activity manager.

29. The program set forth in claim 25, wherein the transaction tracking logic is adapted to provide the application with the ability to track debug activity.
